(19) United States
(12) Patent Application Publication
(10) Pub. No.: US 2020/0031018 A1
(43) Pub. Date: Jan. 30, 2020

(54) ANTIBACTERIAL RESIN AND MANUFACTURING METHOD THEREFOR

(71) Applicants: Jaehack SUNG, Daegu (KR); Sangmin SUNG, Daegu (KR); Somi SUNG, Daegu (KR)

(72) Inventors: Jaehack SUNG, Daegu (KR); Sangmin SUNG, Daegu (KR); Somi SUNG, Daegu (KR)

(21) Appl. No.: 16/486,851

(22) PCT Filed: Mar. 19, 2018
(86) PCT No.: PCT/KR2018/003146

§ 371 Date: Aug. 19, 2019

(30) Foreign Application Priority Data
Apr. 3, 2017 (KR) 10-2017-0042824

(51) Int. Cl. B29B 9/02; B29B 11/10; C08J 3/12

(52) U.S. Cl. CPC B29B 9/02; B29B 11/10; C08J 3/12; C08J 2323/06; C08K 3/015; C08J 2323/12; C08J 2327/06; C08J 2375/04; C08J 2367/03; C08J 2325/06

(57) ABSTRACT

A method for manufacturing an antibacterial resin according to the present invention includes the following steps. The method includes: a preparation step of preparing synthetic resin powder and an antibacterial additive; a dispersion step of introducing into a mixer the synthetic resin powder together with iron balls having a pointed protrusion formed on an outer surface thereof and dispersing particles; a dispersion and mixing step of introducing the antibacterial additive into the mixer containing the synthetic resin powder, followed by dispersion and mixing; a pellet forming step of separating the iron balls and forming the mixture of the synthetic resin powder and the antibacterial additive into pellets by melting, extrusion and cutting; and a product producing step of introducing the pellets into an injection molding machine to produce an antibacterial resin product; wherein white charcoal powder is included in the antibacterial additive in the mixing step.

### TECHNICAL FIELD

The present invention relates to an antibacterial resin and a manufacturing method therefor, and more specifically to a method for manufacturing an antibacterial resin by mixing and molding natural zeolite and synthetic resin in order to improve antibacterial activity and safety in the fields in which resin is used.

### BACKGROUND ART

Generally, it is known that thermoplastic resins and the like, which are used as raw materials for plastics, can provide nutrients for the growth of microorganisms, and thus the growth of bacteria on the plastics is possible. As the applications of these plastics are gradually expanded to electronic products and household goods, which are used around human life, plastic products exposed to wet atmospheric conditions may provide habitats for various bacteria. In this case, rather than product performance deterioration resulting from resin discoloration caused by bacterial growth, a problem arises in that bacteria living on the surface of the plastic products infect the human body. Especially for infants, a problem arises in that, because moisture such as sweat is present in the human body including hands in order to dissipate generated heat, bacteria present on the plastic products cause diseases or have a fatal effect on health.

In particular, infant toys or cutting boards made of plastic may be taken as examples. The toys are manufactured to be used in direct contact with the infant's skin, and in the case of these toys, a problem arises in that bacteria living on the plastic surface are particularly harmful to the human body. In addition, this problem is more serious in the case of cutting boards. When food ingredients are trimmed with a knife, knife cuts must be made on the cutting board, and in many cases, bacteria live in such cuts. Due to these bacteria, a problem arises in that the likelihood of bacteria entering the human body is further increased because of the use of the cutting board to cut food ingredients.

Meanwhile, as for zeolites, there are many types of zeolites, but these types of zeolites have commonality in terms of high water content, crystalline properties, acid phase, and the like. Zeolites have a hardness of not more than 6 and a specific gravity of about 2.2. Zeolites are generally colorless transparent or white translucent, and were named because they boil and swell when heated with a blowpipe. Zeolites have a three-dimensional framework structure consisting of (Si,Al)O₄ tetrahedral units linked together by apical oxygen atoms, like feldspar, but have pores containing water molecules and exchangeable cations. The water molecules are easily removed by heating at relatively low temperatures, but the structural framework does not change, and thus is filled with water by absorbing atmospheric water vapor. The chemical composition of zeolites may be represented by [W_{y}(Si,Al) (O₂ₓₙH₂O)]. Here, W is mainly based on Na and Ca, and also includes K, Mg, Ba, Li, etc. The application of zeolites in the industrial fields is entirely because the unique mineral properties of these zeolites, that is, (1) cation-exchange properties, (2) adsorption and molecular sieve properties, (3) catalytic properties, and (4) dehydration and resorption properties, have effective value in the related industries.

As for the main industrial use of zeolites in light of these properties, the bonding between atoms in the crystalline structure of zeolites is loose, and thus even when water filling between the atoms is released with high heat, the framework is maintained without changes and has the property of adsorbing other particulate materials. Based on this property, the zeolites are generally used as adsorbents or molecular sieves that separate particulate materials having different sizes. However, heretofore, no attention has been paid to the fact that zeolites exhibit antibacterial activity after combined with synthetic resins.

In this situation, a conventional art and its problems will be described below.

As a conventional art for solving bacterial growth on plastics, an antibacterial water bucket is produced using a gel coating method by adding 1.0 to 3.0 wt % of an inorganic antibacterial agent to a fiber reinforced polymer (FRP) for enhancing impact strength, and in this case, the surface of the product is coated with a thin layer. However, this method has problems in that a coating process should be added to the production process, the finished product loses its antibacterial effect which the surface coating layer is worn or peeled off due to the long-term use of the product, and the use of reinforcing fibers (glass fiber) makes it difficult to apply the product universally except for specific applications.

### DISCLOSURE

### Technical Problem

Problems to be solved by an antibacterial resin and a manufacturing method therefor according to the present invention are as follows:

First, the present invention is intended to solve the problem that, as the applications of plastics are gradually expanded to electronic products and household goods, which are used around human life, plastic products exposed to wet atmospheric conditions may provide habitats for various bacteria, bacteria present on these plastic products cause diseases or have a fatal effect on health.

Second, the present invention is intended to solve the problem that the main industrial use of zeolite is generally as adsorbents or as molecular sieves that separate particulate materials having different sizes, but methods based on the property of zeolite that exhibits antibacterial activity after combined with synthetic resin are insufficient.

Third, the present invention is intended to solve the problem that a coating process should be added to a production process in an antibacterial coating method according to a conventional art, the problem that the finished product loses its antibacterial effect when the surface coating layer is worn or peeled off due to the long-term use of the product, and the problem that the use of reinforcing fibers (glass fiber) makes it difficult to apply the product universally except for specific applications.

### Technical Solution

An antibacterial resin and a manufacturing method therefor according to the present invention for solving the above-described problems are as follows:

The method includes: a preparation step of preparing synthetic resin powder and an antibacterial additive; a dispersion step of, after the preparation step, introducing into a mixer the synthetic resin powder together with iron balls having a pointed protrusion formed on an outer surface thereof and dispersing particles; a dispersion and mixing step of, after the dispersion steps, introducing the antibacterial additive into the mixer containing the synthetic resin powder, followed by dispersion and mixing; a pellet forming step of, after the dispersion and mixing step, separating the iron balls and forming the mixture of the synthetic resin powder and the antibacterial additive into pellets by melting, extrusion and cutting; and a product producing step of, after the pellet forming step, introducing the pellets into an injection molding machine to produce an antibacterial resin product; wherein white charcoal powder is included in the antibacterial additive in the mixing step.

The pellet forming step may be performed using a pellet forming machine including: a cylinder open at one end; a piston inserted in the cylinder and having compression function; dies provided opposite to the piston in the cylinder and configured to form pellets; a heating wire wound around the outer surface of the cylinder and configured to generate heat by supply of electricity; and a frame configured to rotatably support the cylinder.

The pellet forming step may include: an injection step of injecting the mixture of the synthetic resin powder and the antibacterial additive into an inlet of the cylinder of the pellet forming machine; a melting step of, after the injection step, rotating the cylinder so that the dies face upwards, and applying electricity to the heating wire to heat the cylinder; a mixing step of, after the melting step, rotating the cylinder by 180° so that the dies face downwards and then stopping the supply of electricity to the heating wire so that the melt becomes a gel state and the white charcoal powder is uniformly mixed while floating; and an extrusion cutting step of, after the mixing step, lowering the piston so that the gel-state melt is extruded in the form of noodles through the dies and cutting the extruded melt with a cutter to form pellets.

In addition, the antibacterial additive may include, based on 100 parts by weight of the mixture, 0.5 to 2 parts by weight of natural zeolite, 0.5 to 1 part by weight of colloidal nano-sized silver, and 2 to 5 parts by weight of the white charcoal powder.

In another embodiment, the antibacterial additive may include, based on 100 parts by weight of the mixture, 0.5 to 2 parts by weight of natural zeolite, 0.5 to 1 part by weight of any one selected from among triclosan (5-chloro-2-(2,4-dichlorophenoxy)phenol) and polyhexamethylene biguanide hydrochloride, and 2 to 5 parts by weight of the white charcoal powder.

The antibacterial resin according to the present invention may be produced by the above-described method for manufacturing the antibacterial resin.

### Advantageous Effects

The antibacterial resin and the method for manufacturing the same according to the present invention have the following effects:

First, as the applications of these plastics are gradually expanded to electronic products and household goods, which are used around human life, plastic products exposed to wet atmospheric conditions may provide habitats for various bacteria. However, according to the present invention, antibacterial activity may be imparted to these plastics by the addition of zeolite, thereby minimizing disease occurrence or adverse effects on health.

Second, the main industrial use of zeolite is generally as adsorbents or as molecular sieves that separate particulate materials having different size. However, according to the present invention, a resin exhibiting antibacterial activity may be produced by combining zeolite with synthetic resin, and thus industrial ripple effects may be expected.

Third, according to the present invention, a resin product may be produced integrally with natural zeolite, and thus may be semi-permanently used and may be universally applied to products that include resin.

Fourth, using natural zeolite and the like as antibacterial additive, a resin product may be produced, which is harmless to the human body, has antibacterial properties, and has no adverse effect on the human body.

Fifth, natural zeolite particles may be uniformly dispersed in a resin product through processes of dispersing and mixing natural zeolite, so that antibacterial function can be exerted throughout the resin product. Thus, the demand for the resin product may be expanded to various applications, including kitchen utensils, such as tableware, cutting boards, and water buckets, baby goods, such as baby bottles and toys, various synthetic fiber products, cases for electronic products, and building materials, such as interior and exterior materials.

Sixth, white charcoal powder may be uniformly mixed with a synthetic resin melt using a rotating cylinder, and thus the white charcoal powder may exhibit sterilization, offensive odor treatment, electromagnetic shielding, far infrared radiation, and anion release effects. Thus, it can exhibit synergistic antibacterial effects with natural zeolite.

### DESCRIPTION OF DRAWINGS

FIG. 1 is a flow chart schematically illustrating a method for manufacturing an antibacterial resin according to one embodiment of the present invention.

FIG. 2 illustrates a pellet forming machine which is used in a pellet forming step of a method for manufacturing an antibacterial resin, and illustrates a state in which dies in the pellet forming machine face upwards.

FIG. 2 illustrates a pellet forming machine which is used in a pellet forming step of a method for manufacturing an antibacterial resin, and illustrates a state in which dies in the pellet forming machine face downwards.

FIG. 4 is a test report on an antibacterial test for an antibacterial resin according to one embodiment of the present invention.

FIG. 5 is a test report on an antibacterial test for an antibacterial resin according to one embodiment of the present invention.

FIG. 6 is a view illustrating an antibacterial resin according to one embodiment of the present invention in an antibacterial test.

FIG. 7 is a view illustrating an antibacterial resin according to one embodiment of the present invention in an antibacterial test.

### MODE FOR INVENTION

Hereinafter, exemplary embodiments of the present invention will be described in detail with reference to the accompanying drawings so that those skilled in the art may easily implement the present invention. However, in the following description of exemplary embodiments of the present invention, a detailed description of known functions and configurations incorporated herein will be omitted when it may unnecessarily obscure the subject matter of the present invention. In addition, throughout the drawings, the same reference numerals are used to indicate parts having similar functions and actions.

Additionally, when any element is referred to as being connected to other element, it not only refers to a case where the element is connected directly to the other element, but also refers to a case where the element is connected indirectly to the other element with a third element interposed therebetween. In addition, including any element means that other elements are not excluded, but are further included, unless specifically stated otherwise.

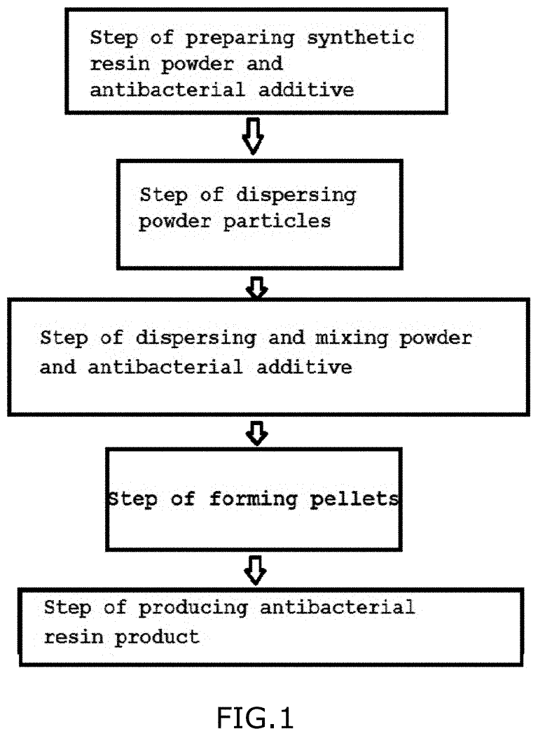

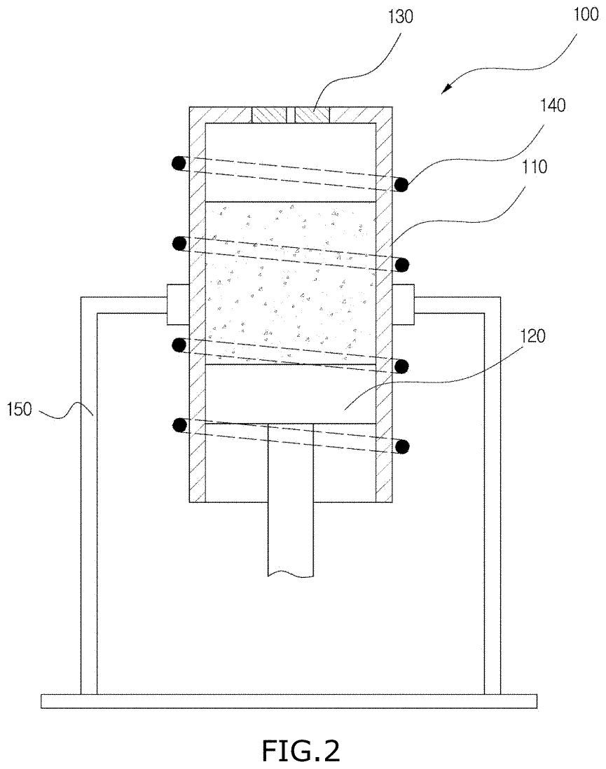

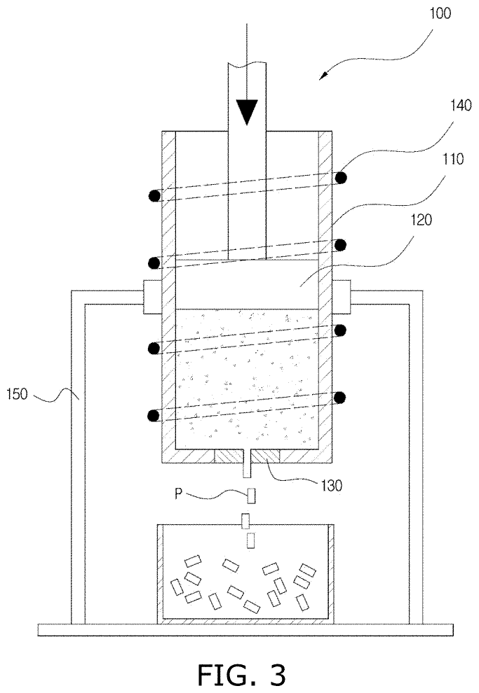

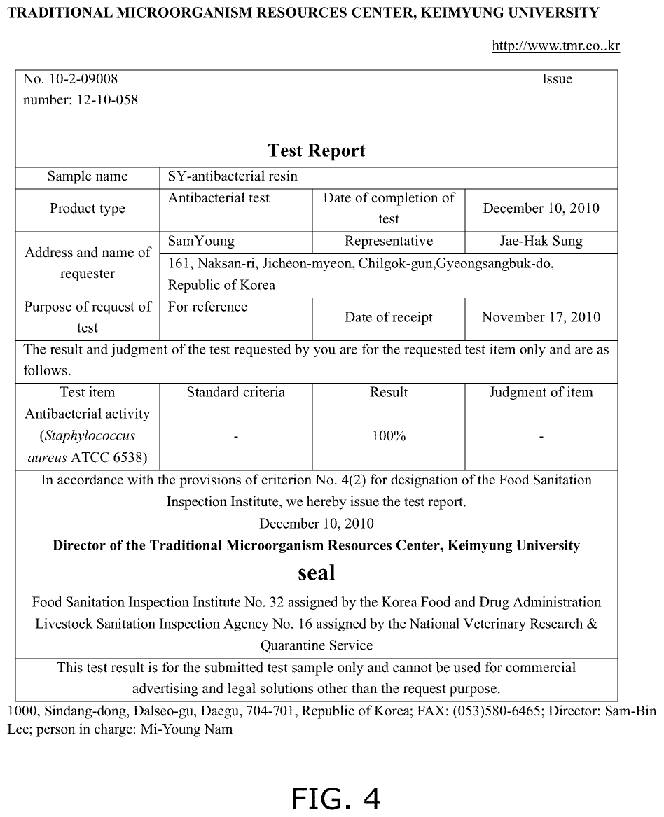

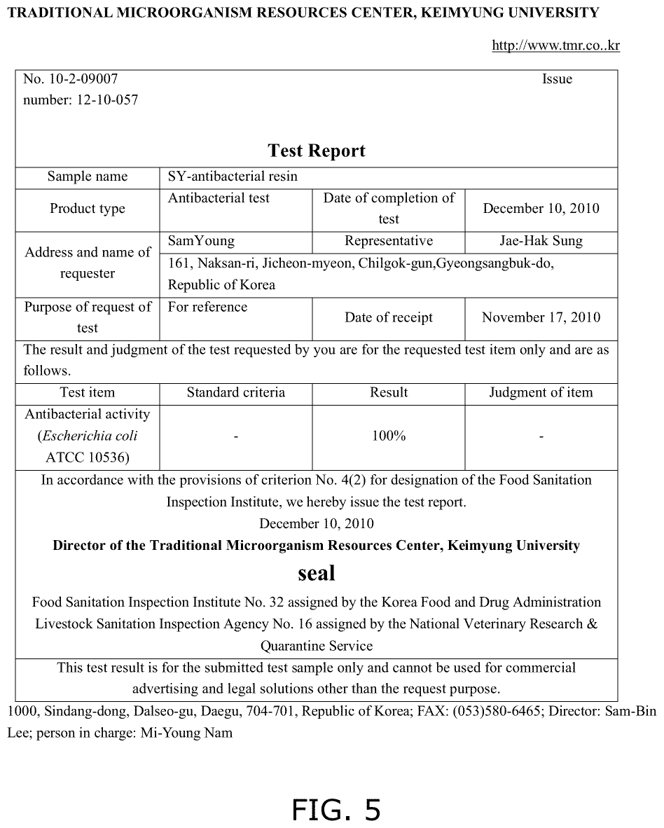

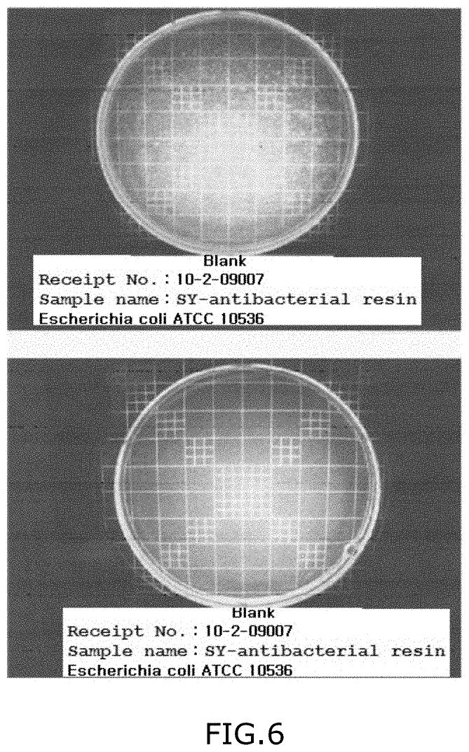

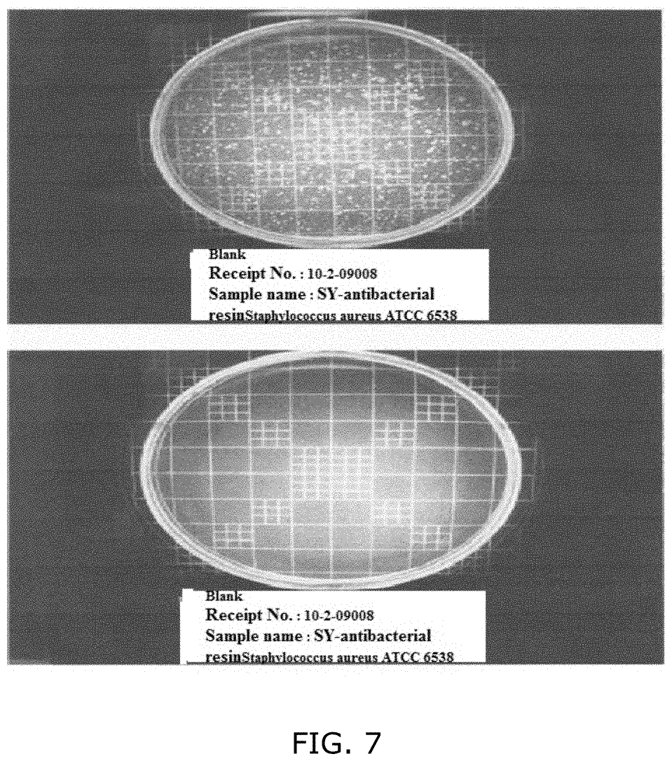

FIG. 1 is a flow chart schematically illustrating a method for manufacturing an antibacterial resin according to one embodiment of the present invention; FIG. 2 illustrates a pellet forming machine which is used in a pellet forming step of a method for manufacturing an antibacterial resin, in which dies in the pellet forming machine face upwards; FIG. 2 illustrates a pellet forming machine which is used in a pellet forming step of a method for manufacturing an antibacterial resin, in which dies in the pellet forming machine face downwards; FIG. 4 is a test report on an antibacterial test for an antibacterial resin according to one embodiment of the present invention; FIG. 5 is a test report on an antibacterial test for an antibacterial resin according to one embodiment of the present invention; FIG. 6 is a view illustrating an antibacterial resin according to one embodiment of the present invention in an antibacterial test; and FIG. 7 is a view illustrating an antibacterial resin according to one embodiment of the present invention in an antibacterial test.

As illustrated in FIG. 1, a method for manufacturing an antibacterial resin according to one embodiment of the present invention includes: (1) a preparation step of preparing synthetic resin powder and antibacterial additive; (2) a dispersion step of introducing into a mixer the synthetic resin powder prepared in step (1), and dispersing the powder particles by operation of the mixer for 2 minutes; (3) a dispersion and mixing step of introducing the antibacterial additive into the mixer containing the synthetic resin powder subjected to step (2), followed by dispersion and mixing for 15 minutes; (4) a pellet forming step of forming pellets (P) by melting, extruding and cutting the mixture subjected to step (3); and (5) a product producing step of introducing the formed pellets (P) into an injection molding machine, thereby producing an antibacterial product.

Hereinafter, an example of the method for manufacturing an antibacterial resin according to the present invention will be described.

### EXAMPLE

(1) Preparation Step

As an example, as the synthetic resin powder, one or more selected from among PE (polyethylene), PP (polypropylene), PS (polystyrene), TPU (thermoplastic polyurethane), PVC (polyvinyl chloride), ABS (acrylonitrile butadiene styrene resin), nylon, melamine resin, and PET (polyethylene terephthalate) is used after powdering. The reason for preparing the synthetic resin as powder as described above is to mix it uniformly with the antibacterial additive in a subsequent dispersion step. In addition, the antibacterial additive is also preferably used after powdering so that it can be easily mixed with the synthetic resin powder.

(2) Dispersion Step

Step (2) is a step of introducing into a mixer the synthetic resin powder prepared in step (1), and dispersing the powder particles by operation of the mixer for 2 minutes. Even when the PE (polyethylene), PP (polypropylene), PS (polystyrene), TPU (thermoplastic polyurethane), PVC (polyvinyl chloride), ABS (acrylonitrile butadiene styrene resin), nylon, melamine resin, and PET (polyethylene terephthalate) are powdered, the powder is lumpy in many cases. For this reason, the operation of dispersing the powder is performed as a preliminary operation to facilitate melting or improve mixing with the antibacterial additive. The mixer refers to a conventional machine or device that mixes powder. That is, any mixer may be used as long as it is a mixer capable of uniformly dispersing particles of the powder. However, a conventional mixer which is industrially used will be preferred, and the operation of dispersing the powder particles is performed using this conventional mixer which is industrially used. At this time, a plurality of iron balls, which are 2 to 3 cm in diameter and have a pointed protrusion formed on the outer surface thereof, may be added to the synthetic resin powder to improve the dispersion effect. In this case, the powder may be more easily dispersed.

(3) Dispersion and Mixing Step

Step (3) is a dispersion and mixing step of introducing the antibacterial additive into the mixer containing the synthetic resin powder subjected to step (2), followed by dispersion and mixing for 15 minutes. Namely, in a state in which powder particles of one or more synthetic resins selected from among PE (polyethylene), PP (polypropylene), PS (polystyrene), TPU (thermoplastic polyurethane), PVC (polyvinyl chloride), ABS (acrylonitrile butadiene styrene resin), nylon, melamine resin, and PET (polyethylene terephthalate) are dispersed, the antibacterial additive is added to the powder particles and mixed uniformly with the power particles while it is dispersed. Through this dispersion and mixing step, the powder particles and the antibacterial additive is mixed uniformly and melted. Through this process, the antibacterial additive may be dispersed uniformly throughout the resin product without being concentrated in any specific portion of the resin product, and thus can exhibit antibacterial properties uniformly throughout the resin product. At this time, they may be more easily dispersed and mixed by the iron balls.

The antibacterial additive includes natural zeolite. For reference, a material safety data sheet for the natural zeolite is as follows.

A test was performed in accordance with KS E 3076:2002 and JIS M 8852:1998 under the environmental conditions of temperature of 19.0° C. to 25.0° C. and relative humidity (R.H.) of 30 to 60%. As shown below, the risk, harmfulness, toxicity and environmental impact of the natural zeolite all had no adverse effects on the human body.

TABLE 1

| | |
|---|---|
| Component names | Silicic acid: 66.50%; aluminum oxide: 14.70%; |
| and composition | iron oxide: 1.68%; magnesium oxide: 1.25%; |
| | calcium oxide: 1.82%; sodium oxide: 1.90%; |
| | potassium oxide: 3.25%; phosphoric acid oxide: |
| | 0.04%; water of crystallization (+H₂ O): 8.04% |
| Risk and | Information on emergency risk and harmfulness: |
| harmfulness | not applicable; effect on eyes: can feel |
| | foreign body sensation, but harmless; effect |
| | when inhaled: harmless; effect when ingested: |
| | harmless; chronic signs and symptoms: no signs |
| | and symptoms |
| Physicochemical | Appearance: light white; odor: none; pH: 6.5 |
| properties | to 7.5; solubility: insoluble; boiling point: |
| | not applicable; melting point: 1920; |
| | explosive: not applicable; oxidative: not |
| | applicable; density: 1.91 to 2.91 gm/cm² |
| Stability and | Chemical stability: stable; conditions and |
| reactivity | materials to be avoided: not applicable; |
| | hazardous materials generated during |
| | decomposition: not applicable; possibility of |
| | generation of hazardous substances during |
| | reaction: not applicable |
| Information on | Not applicable |
| toxicity | |
| Environmental | Aquatic ecotoxicity: not applicable; mobility |
| impact | in soil: not applicable; persistence and |
| | degradability: not applicable; possible of |
| | bioaccumulation in animals and plants: not |
| | applicable |
| Regulatory | Not applicable |
| status | |

Hereinafter, the contents of the natural zeolite and the powder will be described. The reason for changing these contents is to exhibit excellent antibacterial activity.

The natural zeolite may be contained in an amount of 0.5 to 15 parts by weight based on 100 parts by weight of the mixture. The present invention is characterized in that the antibacterial additive includes natural zeolite. When the natural zeolite was contained in an amount of 0.5 to 15 parts by weight based on the total weight (100 parts by weight) of the mixture as described above, the produced antibacterial resin exhibited an antibacterial effect.

In addition, the natural zeolite may also be contained in an amount of 0.5 to 2 parts by weight based on 100 parts by weight of the mixture. When the natural zeolite was contained in an amount of 0.5 to 2 parts by weight, the antibacterial effect was maximized as shown in FIGS. 6 and 7. The results of testing this sample are shown in FIGS. 6 and 7.

For testing, in accordance with the disinfectant test method of “temporary criteria and certified standard criteria of sterilizers for devices and the like” of Korea Food and Drug Administration Notification No. 2005-75, a disinfectant product to be measured was diluted to the use concentration according to the method of use, and each of Escherichia coli ATCC 10536 and Staphylococcus aureus ATCC 6538 was treated with the diluted disinfectant product at 20° C. for 5 minutes. Then, whether the disinfectant product reduced the initial bacterial count by 99.999% or higher was examined. As shown in FIG. 6, when the natural zeolite was contained in an amount of 0.5 to 2 parts by weight based on 100 parts by weight of the mixture, an antibacterial activity of 100% against Staphylococcus aureus ATCC 6538 as a test strain was obtained. Likewise, as shown in FIG. 7, when the natural zeolite was contained in an amount of 0.5 to 2 parts by weight based on 100 parts by weight of the mixture, an antibacterial activity of 100% against Escherichia coli ATCC 10536 as a test strain could be obtained.

As shown in FIG. 6 showing the result of testing antibacterial activity against Staphylococcus aureus, the upper photograph for a sample not containing the natural zeolite looks white, indicating that the E. coli lived, and the lower photograph for a sample containing the natural zeolite according to the present invention looks clean, indicating that the E. coli was killed. As shown in FIG. 7 showing the result of testing antibacterial activity against Staphylococcus aureus, the upper photograph for a sample not containing the natural zeolite looks white, indicating that the Staphylococcus aureus lived, and the lower photograph for a sample containing the natural zeolite according to the present invention looks clean, indicating that the Staphylococcus aureus was killed.

An example of a comparative test performed while changing the content of the antibacterial additive (natural zeolite) based on 100 parts by weight of the mixture will be described in detail below.

Here, the antibacterial additive includes, in addition to the natural zeolite, colloidal nano-sized silver and white charcoal powder. Specifically, the antibacterial additive may include, based on 100 parts by weight of the mixture, 0.5 to 2 parts by weight of the natural zeolite, 0.5 to 1 part by weight of colloidal nano-sized silver and 2 to 5 parts by weight of white charcoal powder. The colloidal nano-sized silver refers to one obtained by finely splitting silver into nano-sized particles by electrolysis or a chemical method. Silver has been widely used as a material for treating poisons in both East and West. In recent years, experimental results have been reported which indicate that silver can kill most single-celled bacteria and bacteria around us. When silver meets oxygen in the air, the oxygen atoms of the oxygen molecule adhere to the silver, and these oxygen atoms adhere to and oxidize the cell membranes of bacteria and the like, thereby destroying the cell membranes and exhibiting bactericidal action. Silver is an expensive precious metal, but when it is split into nano-sized particles so as to have an increased contact area, the silver particles can exhibit excellent antibacterial and sterilization effects even when used in small amounts. Since these colloidal nano-sized silver particles are fine particles that agglomerate in many cases, the role of step (3) for dispersion is very important. In addition, the colloidal nano-sized silver exhibits an excellent antibacterial effect by acting synergistically with the natural zeolite. This effect will be described in detail below.

In addition, the white charcoal powder has a high carbon content, and thus exhibits excellent sterilization, anion release, far infrared radiation, and offensive odor treatment effects. The carbon content of the white charcoal powder is 90 to 95%, and the particle size is 47.5 to 56.5 μm so that smooth mixing of the white charcoal powder is possible.

In another embodiment, the antibacterial additive may include, based on 100 parts by weight of the mixture, 0.5 to 2 parts by weight of natural zeolite, 2 to 5 parts by weight of white charcoal powder, and 0.5 to 1 part by weight of any one selected from among triclosan (5-chloro-2-(2,4-dichlorophenoxy) phenol) and polyhexamethylene biguanide hydrochloride.

The triclosan shows high activity against Staphylococcus aureus, and is used as an antibacterial and sterilizing agent in a wide range of applications. It is mainly used in health care products, such as soaps, shower gels, deodorant soaps, hand lotions and creams, toothpastes, mouthwashes, and armpit deodorants, and is added to household items, such as computer keyboards, toys, mattresses, and cutting boards.

When a person absorbs or is exposed to an excessive amount of the triclosan, fresh air should be provided, and when respiratory arrest occurs due to an excessive amount of the triclosan, artificial respiration should be given. When the skin is exposed to an excessive amount of the triclosan, washing with a sufficient amount of water is required, and when eyes are exposed to an excessive amount of the triclosan, washing with a sufficient amount of water for at least 15 minutes is required. Thus, absorption of or exposure to an excessive amount of the triclosan poses a risk of harmful effects on the human body, and for this reason, the triclosan should be used in proper amounts.

The polyhexamethylene biguanide hydrochloride is often used as a bactericidal preservative. On Sep. 9, 2011, the Risk Assessment Committee of the European Chemicals Agency published a report on the adverse effects of the polyhexamethylene biguanide hydrochloride on the human body. Specifically, regarding toxicity, the report indicates that when the polyhexamethylene biguanide hydrochloride is eaten for 14 consecutive days, increased saliva, increased tears, lifted hair or cilia, and depression signs are expressed, but do not last for more than 7 to 8 days. This toxicity is currently a problem, but the side effects of the polyhexamethylene biguanide hydrochloride are not recognized unless it is ingested in high concentrations or excessive amounts. Therefore, it should be noted that the polyhexamethylene biguanide hydrochloride should also be used in proper amounts.

The antibacterial activity shown when any one selected among from triclosan (5-chloro-2-(2,4-dichlorophenoxy)phenol) and polyhexamethylene biguanide hydrochloride is used together with the natural zeolite as the antibacterial additive will be described in detail below.

(4) Pellet Forming Step

Step (4) is a step of forming step of forming pellets (P) by melting, extruding and cutting the synthetic resin powder and the antibacterial additive, dispersed and mixed in step (3).

At this time, a pellet forming machine 100 as shown in FIGS. 2 and 3 is used. The pellet forming machine 100 includes: a cylinder 110 open at one end; and a piston 120 inserted in the cylinder 110 and having compression function. Furthermore, dies 130 for forming pellets (P) are provided opposite to the piston 120 in the cylinder 110. In addition, a heating wire 140 that generates heat by supply of electricity is wound around the outer surface of the cylinder 110. In addition, the cylinder 110 is rotatably mounted in a frame 150. In addition, in the cylinder 110, there is formed an inlet (not shown) into which the mixture of the synthetic powder and the antibacterial additive may be injected, and a stopper (not shown) capable of opening and closing the inlet (not shown) is also provided.

The pellet (P) forming process which is performed using the pellet forming machine 100 will now be described.

An injection step of injecting the mixture of the synthetic powder and the antibacterial additive into the inlet of the cylinder 110 is performed.

After the injection step, the cylinder 110 is rotated so that the dies 130 face upwards. In this step, a melting step of heating the cylinder 110 to a temperature of 100 to 150° C. by applying electricity to the heating wire 140 is performed. At this time, the heating may be performed for 20 to 30 minutes when the amount of the mixture is 30 kg, thereby making a liquid melt.

After the melting step, a mixing step of uniformly mixing white charcoal powder included in the antibacterial additive is performed. In the melting step, a phenomenon occurs in which the white charcoal powder floats to the surface of the melt due to its lower density than the melted synthetic resin. This phenomenon can be easily understood from the fact that impurities float when gold or silver, for example, is melted. Thus, in the mixing step, in order to uniformly distribute the white charcoal powder, the cylinder 110 is rotated by 180° so that the dies 130 face downwards. Then, the floated white charcoal powder is located at the bottom level again, and thus floats toward the piston 120 facing upwards. At this time, the supply of electricity to the heating wire is stopped. Then, the floating speed of the white charcoal powder becomes slower while the melt becomes a gel state. When 15 to 20 minutes have elapsed for 30 kg of the melt, the white charcoal powder reaches a state in which it is uniformly distributed in the melt. The reason why the white charcoal powder does not completely float to the top surface is because the viscosity of the melt increases while heat generation of the heating wire 140 is stopped. At this time, of course, the dies are in s state in which they are closed to prevent the melt from flowing down into the dies.

After the mixing step, an extrusion cutting step is performed in which the closed dies are opened and the piston 120 is lowered so that the gel-state melt is extruded in the form of noodles through the dies 130, and the extruded melt is cut with a cutter, thereby forming pellets (P). The pellets (P) are naturally solidified in the air. The pellets (P) formed as described above are in a state in which the fine coal powder is evenly mixed.

(5) Product Producing Step

Step (5) is a step of introducing the formed pellets into an injection molding machine, thereby producing an antibacterial resin product.

The pellets, formed from the powder and the antibacterial additive, are finally formed into an antibacterial resin product through injection molding.

At this time, a melt of the pellets is injected into the injection molding machine, and injection molding is achieved within a few seconds. Thus, the phenomenon that the white charcoal powder becomes non-uniform due to upward floating does not occur.

As a result, the antibacterial resin produced according to the method for manufacturing the antibacterial resin is finally produced into an antibacterial resin product.

Hereinafter, an antibacterial effect depending on the type and content of the antibacterial additive used in the antibacterial resin will be described by way of Test Examples.

### Test Example 1

The extent to which natural zeolite used as the antibacterial additive exhibits antibacterial activity depending on its content will now be described.

For testing, in accordance with the disinfectant test method of “temporary criteria and certified standard criteria of sterilizers for devices and the like” of Korea Food and Drug Administration Notification No. 2005-75, a disinfectant product to be measured was diluted to the use concentration according to the method of use, and each of Escherichia coli ATCC 10536 and Staphylococcus aureus ATCC 6538 was treated with the diluted disinfectant product at 20° C. for 5 minutes. Then, it was examined how much the initial bacterial count was reduced. The test was performed depending on the content of the natural zeolite based on 100 parts by weight of the mixture.

TABLE 2

| | | 0.5 to 2 parts by | 0.5 to 15 parts |
|---|---|---|---|
| | Not containing | weight of natural | by weight of |
| | natural zeolite | zeolite | natural zeolite |
| Escherichia | 0% | 100% | 78% |
| coli | | | |
| Staphylococcus | 0% | 100% | 85% |
| aureus | | | |

As shown in Table 2 above, when the natural zeolite was used as the antibacterial additive, the antibacterial effect thereof was demonstrated when the content thereof was 0.5 to parts by weight, but the antibacterial effect was maximized when the content was 0.5 to 2 parts by weight.

### Test Example 2

A test example performed using the natural zeolite, the colloidal nano-sized silver and the white charcoal powder as the antibacterial additive will now be described. For testing, in accordance with the disinfectant test method of “temporary criteria and certified standard criteria of sterilizers for devices and the like” of Korea Food and Drug Administration Notification No. 2005-75, a disinfectant product to be measured was diluted to the use concentration according to the method of use, and each of Escherichia coli ATCC 10536 and Staphylococcus aureus ATCC 6538 was treated with the diluted disinfectant product at 20° C. for each of 2 minutes, 3 minutes and 5 minutes. Then, it was examined how much the initial bacterial count was reduced.

TABLE 3

| | Containing natural zeolite, colloidal nano-sized | | |
|---|---|---|---|
| | silver and white charcoal powder | | |
| | After 2 minutes | After 3 minutes | After 5 minutes |
| Escherichia | 98% | 100% | 100% |
| coli | | | |
| Staphylococcus | 97% | 99.9% | 100% |
| aureus | | | |

### Test Example 3

A test was performed using the mixture containing, based on 100 parts by weight of the mixture, 0.5 to 2 parts by weight of the natural zeolite, 2 to 5 parts by weight of the white charcoal powder, and 0.5 to 1 part by weight of any one selected from among triclosan (5-chloro-2-(2,4-dichlorophenoxy) phenol) and polyhexamethylene biguanide hydrochloride, as the antibacterial additive. The test was performed under the same conditions as described in Test Example 2 above.

TABLE 4

| | Containing natural zeolite, triclosan and white | | |
|---|---|---|---|
| | charcoal powder | | |
| | After 2 minutes | After 3 minutes | After 5 minutes |
| Escherichia | 75% | 89% | 100% |
| coli | | | |
| Staphylococcus | 92% | 98% | 100% |
| aureus | | | |

It was shown in the test that the triclosan was effective against Staphylococcus aureus. The triclosan exhibited faster antibacterial activity against Staphylococcus aureus than against Escherichia coli.

TABLE 5

| | Containing natural zeolite, polyhexamethylene | | |
|---|---|---|---|
| | biguanide hydrochloride and white charcoal powder | | |
| | After 2 minutes | After 3 minutes | After 5 minutes |
| Escherichia | 84% | 91% | 100% |
| coli | | | |
| Staphylococcus | 89% | 94% | 100% |
| aureus | | | |

As described above, the antibacterial resin and the method for manufacturing the same according to one embodiment of the present invention have the following effects. First, as the applications of these plastics are gradually expanded to electronic products and household goods, which are used around human life, plastic products exposed to wet atmospheric conditions may provide habitats for various bacteria. However, according to the present invention, antibacterial activity may be imparted to these plastics by the addition of zeolite, thereby minimizing disease occurrence or adverse effects on health. Second, the main industrial use of zeolite is generally as adsorbents or as molecular sieves that separate particulate materials having different size. However, according to the present invention, a resin exhibiting antibacterial activity may be produced by combining zeolite with synthetic resin, and thus industrial ripple effects may be expected. Third, according to the present invention, a resin product may be produced integrally with natural zeolite, and thus may be semi-permanently used and may be universally applied to products that include resin. Fourth, using natural zeolite and the like as an antibacterial additive, a resin product may be produced, which is harmless to the human body, has antibacterial properties, and has no adverse effect on the human body. Fifth, natural zeolite particles may be uniformly dispersed in a resin product through processes of dispersing and mixing natural zeolite, so that antibacterial function can be exerted throughout the resin product. Thus, the demand for the resin product may be expanded to various applications, including kitchen utensils, such as tableware, cutting boards, and water buckets, baby goods, such as baby bottles and toys, various synthetic fiber products, cases for electronic products, and building materials, such as interior and exterior materials. Sixth, white charcoal powder may be uniformly mixed with a synthetic resin melt using a rotating cylinder, and thus the white charcoal powder may exhibit sterilization, offensive odor treatment, electromagnetic shielding, far infrared radiation, and anion release effects. The white charcoal powder has a carbon content reaching 93%, unlike black charcoal powder having a carbon content of 65 to 85%, and thus has a better effect, and the efficacy thereof has already been proven in academia. Seventh, the white charcoal powder cannot be mixed uniformly with a synthetic resin melt. For this reason, in the present invention, the cylinder 110 can introduce the white charcoal powder uniformly into each pellet (P) by using the pellet forming machine 100 which rotates.

The present invention described above may be variously modified or applied by those having ordinary skill in the art to which the present invention pertains, and the scope of the technical spirit of the present invention should be defined by the appended claims.

1. A method for manufacturing an antibacterial resin, the method comprising:
a preparation step of preparing synthetic resin powder and an antibacterial additive;
a dispersion step of, after the preparation step, introducing into a mixer the synthetic resin powder together with iron balls having a pointed protrusion formed on an outer surface thereof and dispersing particles of the powder;
a dispersion and mixing step of after the dispersion step, introducing the antibacterial additive into the mixer containing the synthetic resin powder, followed by dispersion and mixing;
a pellet forming step of, after the dispersion and mixing step, separating the iron balls and forming the mixture of the synthetic resin powder and the antibacterial additive into pellets by melting, extrusion and cutting; and
a product producing step of, after the pellet forming step, introducing the pellets into an injection molding machine to produce an antibacterial resin product;
wherein white charcoal powder is included in the antibacterial additive in the mixing step;
wherein the pellet forming step is performed using a pellet forming machine comprising: a cylinder (110) open at one end; a piston (120) inserted in the cylinder (110) and having compression function; dies (130) provided opposite to the piston (120) in the cylinder (110) and configured to form pellets (P); a heating wire (140) wound around an outer surface of the cylinder (110) and configured to generate heat by supply of electricity; and a frame (150) configured to rotatably support the cylinder (150); and
wherein the pellet forming step comprises:
an injection step of injecting the mixture of the synthetic resin powder and the antibacterial additive into an inlet of the cylinder (110);
a melting step of, after the injection step, rotating the cylinder (110) so that the dies (130) face upwards and applying electricity to the heating wire (140) to heat the cylinder (110);
a mixing step of, after the melting step, rotating the cylinder (110) by 180° so that the dies (130) face downwards and then stopping the supply of electricity to the heating wire (140) so that the melt becomes a gel state and the white charcoal powder is uniformly mixed while floating; and
an extrusion cutting step of, after the mixing step, lowering the piston (120) so that the gel-state melt is extruded in the form of noodles through the dies (130) and cutting the extruded melt with a cutter to form pellets (P); and
wherein the antibacterial additive comprises, based on 100 parts by weight of the mixture, 0.5 to 2 parts by weight of natural zeolite, 0.5 to 1 part by weight of colloidal nano-sized silver, and 2 to 5 parts by weight of the white charcoal powder; or
wherein the antibacterial additive comprises, based on 100 parts by weight of the mixture, 0.5 to 2 parts by weight of natural zeolite, 0.5 to 1 part by weight of any one selected from among triclosan (5-chloro-2-(2,4-dichlorophenoxy) phenol) and polyhexamethylene biguanide hydrochloride, and 2 to 5 parts by weight of the white charcoal powder.
